(19) United States
(12) Patent Application Publication
(10) Pub. No.: US 2013/0209721 A1
(43) Pub. Date: Aug. 15, 2013

(54) Disposable Toilet Bowl Base Area Cover

(71) Applicant: Zakia Mahasa, Baltimore, MD (US)

(72) Inventor: Zakia Mahasa, Baltimore, MD (US)

(73) Assignee: Ms. Zakia Mahasa, Baltimore, MD (US)

(21) Appl. No.: 13/396,864

(22) Filed: Feb. 15, 2012

(51) Int. Cl. B32B 3/02

(52) U.S. Cl. 428/83

(57) ABSTRACT

This invention is in the field of Sanitation/Hygiene. The product is a disposable plastic film that conforms to the base of a toilet bowl and covers the floor area surrounding the toilet bowl base. Its purpose is to prevent drops of urine from dropping on the floor around the toilet, thereby preventing staining, odor and bacteria.

This invention is in the technical field of bathroom hygiene. The product is a disposable plastic film that conforms to the base of a toilet bowl and covers the floor area surrounding the toilet bowl base on the front and sides. An adhesive will keep the invention in place on the floor around the base of the toilet.

### PRIOR ART

Fabric Toilet Rugs. These rugs are not disposable, require washing and hold odor and bacteria.

### DESCRIPTION OF DRAWING

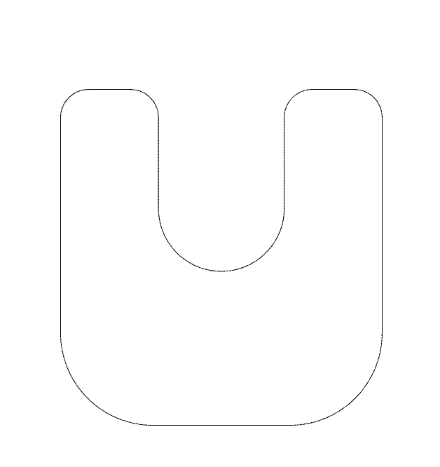

(FIG. 1) The drawing depicts the general shape of the invention, conforming to the shape of the base of a toilet.

### BACKGROUND OF THE INVENTION

Frequently when people, especially males and younger children urinate, they inadvertently splash droplets of urine in front and on the sides of the toilet bowl onto the floor. If not removed immediately, the urine can become odorous and create unsanitary and unhygienic conditions.

### DETAILED DESCRIPTION OF THE INVENTION

Referring now in more detail, the invention is a disposable plastic film covering. The plastic will have adhesive to prevent sliding once in place. It is however easily removable when it is time to discard. The invention will conform to various shapes and styles of toilet bowl bases.

The advantages of this invention are that it prevents frequent cleaning to the area covered by the invention. It provides an inexpensive alternative to frequent cleaning, and unsanitary, unhygienic conditions.

1. The invention should not be limited by the above description, method and examples, but by the embodiments and methods within the scope and spirit of the invention as claimed. This invention will surround and extend in front of and on the sides of the toilet bowl base. It will prevent urine from dropping to the floor underneath the invention. The invention is made of disposable plastic.
